(19) United States
(12) Patent Application Publication
(10) Pub. No.: US 2006/0070806 A1
(43) Pub. Date: Apr. 6, 2006

(54) Ladder with storage compartment

(76) Inventor: Dennis Simpson, Minnetonka, MN (US)

Correspondence Address: PATTERSON, THUENTE, SKAAR & CHRISTENSEN, P.A., 4800 IDS CENTER, 80 SOUTH 8TH STREET, MINNEAPOLIS, MN, 55402-2100, US

(21) Appl. No.: 10/956,727

(22) Filed: Oct. 1, 2004

(51) Int. Cl. E06C 5/32

(52) U.S. Cl. 182/129

(57) ABSTRACT

A ladder including a first ladder section, a second ladder section and a storage compartment. The second ladder section is operably attached to the first ladder section. The storage compartment is attached to at least one of the first ladder section and the second ladder section. The storage compartment includes a storage section with a partially enclosed region formed therein. The storage compartment also includes a closure section that is operably connected to the storage section. The closure section is movable between a closed position where the closure section substantially encloses the partially enclosed region and an open position where the closure portion has a support surface that is capable of supporting at least one object.

### FIELD OF THE INVENTION

The present invention relates generally to ladders. More particularly, the present invention relates to ladders with storage compartments.

### BACKGROUND OF THE INVENTION

Ladders are used in a variety of applications to assist with accessing objects that are located beyond the reach of a person. Ladders are available in a variety of configurations and sizes so that a ladder may be selected that is most appropriate for a particular task.

For example, extension ladders generally include two ladder sections that are slidably mounted with respect to each other. Step ladders generally include two ladder sections that are pivotally mounted with respect to each other.

In many applications it is necessary to hold objects while standing on the ladder. These objects are carried by the person using the ladder either in the person's hands or on in a tool pouch or similar device worn on the person's body. Carrying the items in the user's hands reduces the ability of the user to perform tasks on the ladder and potentially impacts the user's ability to safely use the ladder.

There are various patents that address the issue of assisting person to hold objects while using ladders. Charlebois, U.S. Pat. No. 6,467,577, describes a storage device for attachment to a ladder. The storage device includes a toolbox and a cover that is pivotally attached to the toolbox. The cover hooks over the top of the ladder.

Caron, U.S. Pat. No. 6,401,862, discusses a modular storage device for use with a ladder. The modular storage device includes a central region that extends over the ladder top. Slots are formed along the sides of the central region for attaching additional storage modules to the central region.

Katz et al., U.S. Pat. No. 6,443,260, and Katz, U.S. Pat. No. 5,873,443, both disclose a tray that is attached to the top of a ladder. The tray includes a lower section and an upper section that are pivotally attached to each other. The lower section is placed on the ladder top. The upper section pivots away from the lower section to provide a horizontal surface on which objects can be stored.

Ryszkiewicz, U.S. Pat. No. 6,334,509, describes a caddy for use with a ladder. The caddy includes a center section that is placed over the ladder top. Containers for holding objects are mounted on opposite sides of the center section.

Brown, U.S. Pat. No. 5,971,102, teaches a ladder having storage compartments in the top and steps. The storage compartment in the top includes a lid that pivots to an open position for storing objects.

Ferley, U.S. Pat. No. 5,505,302, describes a toolbox that is suited for attachment to the top of a ladder. A lower surface of the toolbox includes a recess that is adapted to receive the top of the ladder. The top of the toolbox includes a cover to retain objects in the toolbox.

McGee, U.S. Pat. No. 4,356,854, and Carty, U.S. Pat. No. 6,766,881, both disclose flexible tool pouches that are designed to be placed over the top of a ladder.

Schopp et al, U.S. Pat. No. 4,310,134, teaches a utility box that is attachable to the top of a ladder. A pair of resilient clips extends from the bottom of the toolbox for attaching the utility box to the ladder top.

### SUMMARY OF THE INVENTION

A ladder having a first ladder section, a second ladder section and a storage compartment. The second ladder section is operably attached to the first ladder section. The storage compartment is attached to at least one of the first ladder section and the second ladder section.

The storage compartment comprises a storage section having a partially enclosed region formed therein. The storage compartment further comprises a closure section that is operably connected to the storage section. The closure section is movable between a closed position where the closure section substantially encloses the partially enclosed region and an open position where the closure section has a support surface that is capable of supporting at least one object.

### BRIEF DESCRIPTION OF THE DRAWINGS

FIG. 1 is a perspective view of a ladder with storage compartment according to the present invention where the storage compartment is in a closed configuration.

FIG. 2 is a perspective view of the ladder with storage compartment where the storage compartment is in an open position.

FIG. 3 is a front view of the storage compartment.

FIG. 4 is a bottom view of the storage compartment.

FIG. 5 is a lower perspective view of an outer panel of the first closure portion.

FIG. 6 is an upper perspective view of the outer panel of the first closure portion.

FIG. 7 is a lower perspective view of an outer panel of the second closure portion.

FIG. 8 is an upper perspective view of the outer panel of the second closure portion.

FIG. 9 is a top view of an inner panel for the first closure portion.

FIG. 10 is a top view of an inner panel for the second closure portion.

FIG. 11 is a perspective view of an alternate configuration of the storage compartment.

FIG. 12 is a perspective view of an alternate configuration of the storage compartment.

FIG. 13 is a perspective view of an alternate configuration of the storage compartment.

FIG. 14 is a perspective view of an alternate configuration of the storage compartment.

### DETAILED DESCRIPTION OF THE PREFERRED EMBODIMENTS

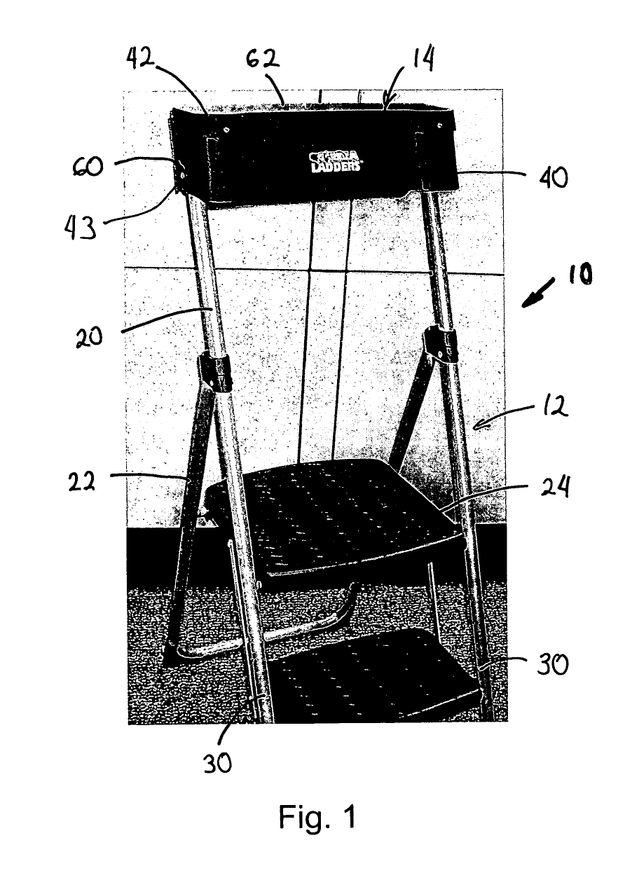

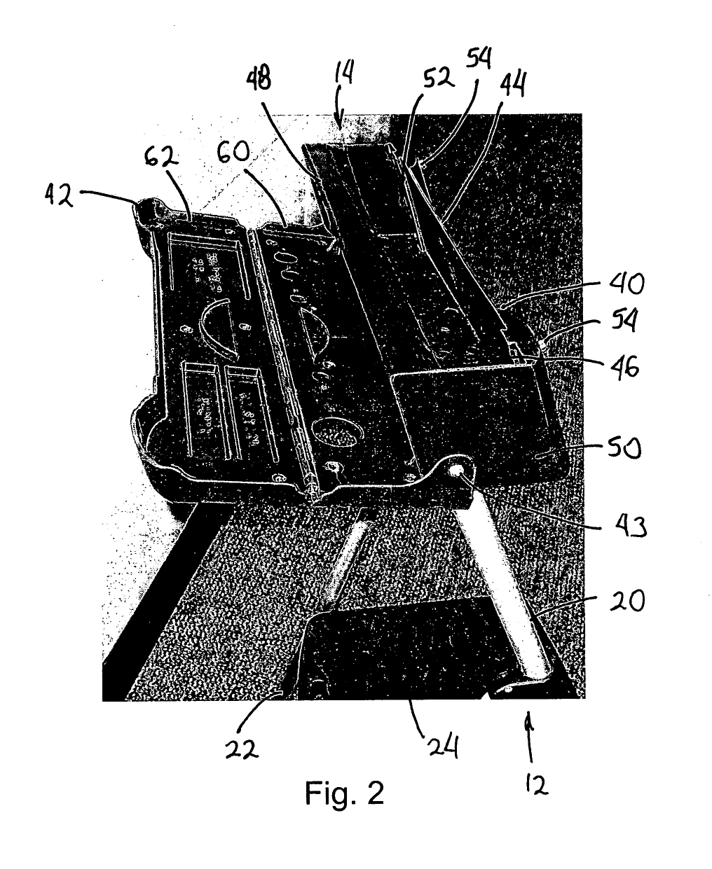

The present invention is a ladder with storage compartment, as illustrated at 10 in FIGS. 1-2. The ladder with storage compartment 10 generally includes a ladder 12 to which a storage compartment 14 is attached.

The ladder with storage compartment 10 enables objects such as screwdrivers and screws that are used in conjunction with the ladder 12 to be readily stored and accessed in the storage compartment 14. The ladder with storage compartment 10 thereby eliminates the need for the person using the ladder 12 to hold these objects in his/her hands or on tool belts or similar objects that are worn by the user. The storage compartment 14 also acts as a handle that a person may use while either walking up the ladder 12 or standing on the ladder 12.

The ladder 12 preferably includes two ladder sections 20, 22 that are pivotally attached to each other to move between a use position where the ladder sections 20, 22 are pivoted apart from each other and a storage position where the ladder sections 20, 22 are pivoted towards each other.

While the concepts of the present invention are described with respect to using the storage compartment 14 with the stepladder 12, a person of ordinary skill in the art will appreciate that the concepts of the present invention are suitable for use with a variety of types of ladders.

The ladder 12 includes at least one step 24 that is operably attached to at least one of the ladder sections 20, 22. As the ladder sections 20, 22 are pivoted between the use position and the storage position, the at least one step 24 may pivot with respect to at least one of the ladder sections 20, 22 to reduce an overall thickness of the ladder 12. The ladder 12 can include two steps 24 that are operably attached to each other to pivot in unison with respect to at least one of the ladder sections 20, 22.

The front ladder section 20 is preferably defined by a pair of side rails 30. The storage compartment 14 is attached to upper ends of the side rails 30 so that the storage compartment 14 extends between the side rails 30.

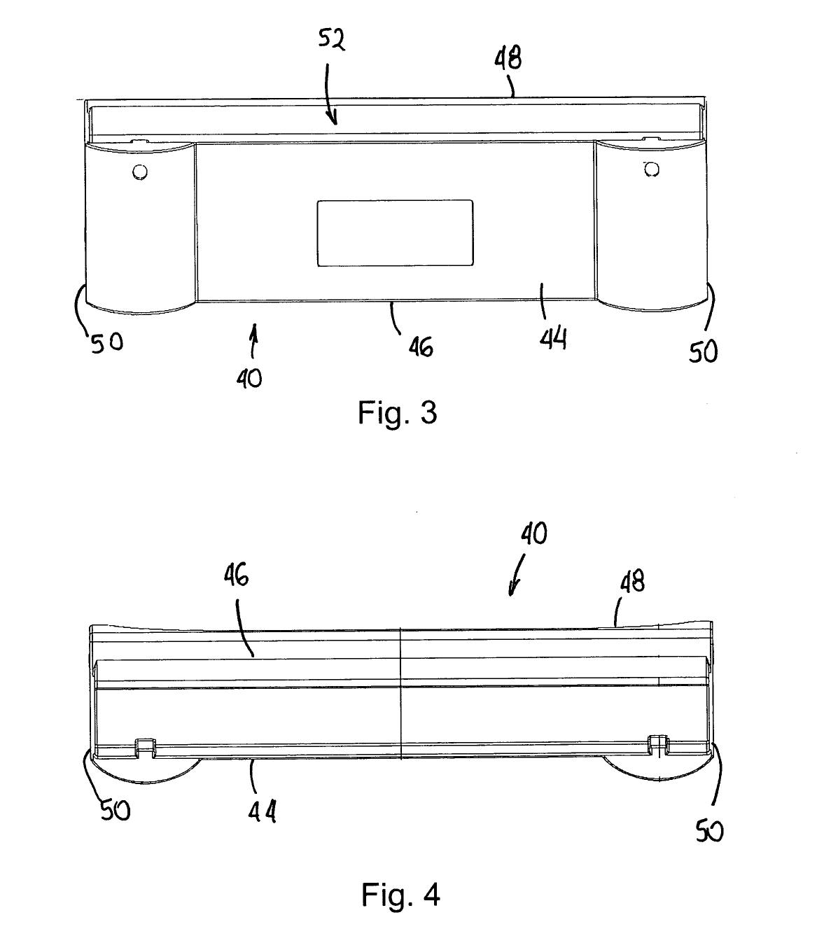

The storage compartment 14 generally includes a storage section 40 to which a closure section 42 is pivotally attached. The storage section 40 has a front panel 44, a bottom panel 46, a back panel 48 and a pair of side panels 50 that define a partially enclosed region 52, as illustrated in FIGS. 3-4. The storage section 40 preferably has a rectangular configuration with a length that is significantly larger than a width. This configuration reduces a thickness of the storage compartment for storage.

The front panel 44 preferably includes at least one closure mechanism 54 such as a resilient tab that is capable of engaging the closure section 42 to maintain the closure section 42 in a closed configuration with respect to the storage section 40.

The closure section 42 preferably includes a two-part configuration with a first closure portion 60 and a second closure portion 62, as illustrated in FIG. 1-2. The first closure portion 60 and the second closure portion 62 are preferably pivotally attached to each other.

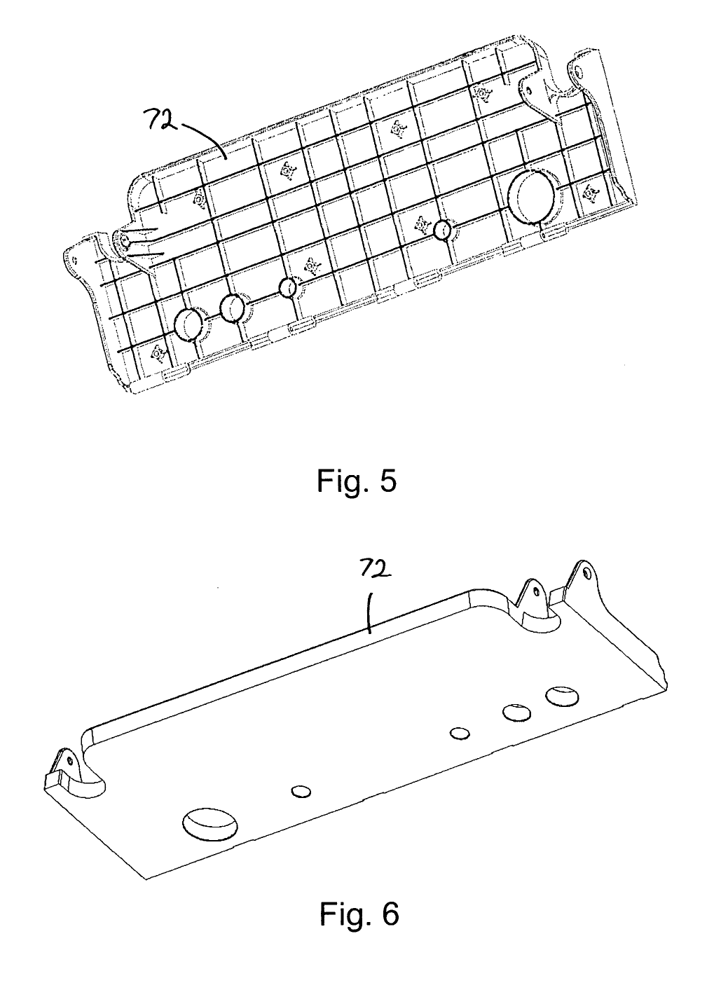

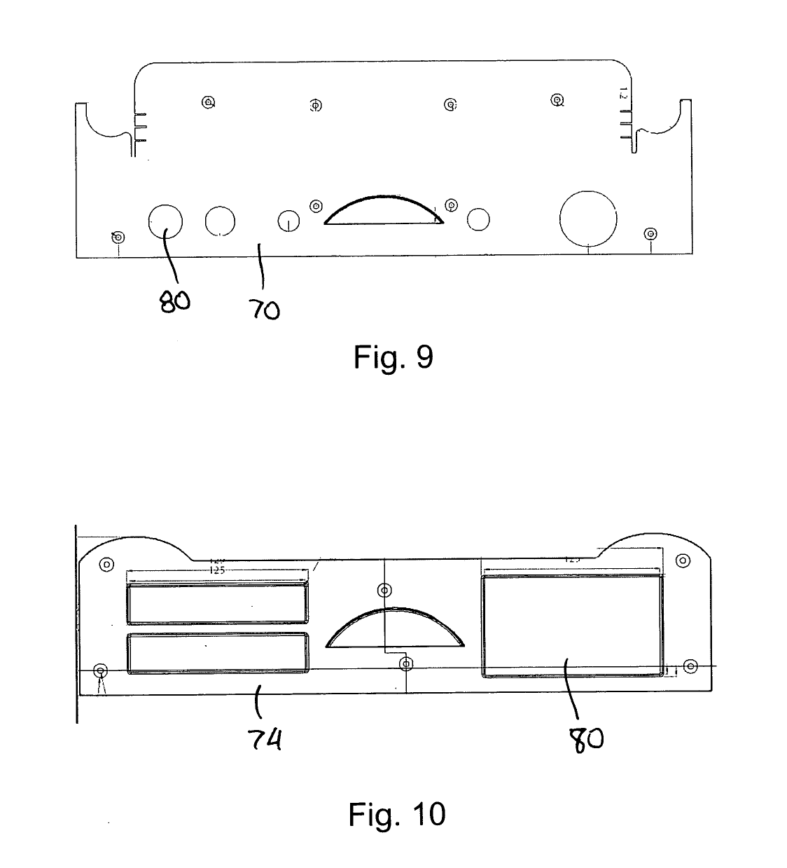

The first closure portion 60 preferably has a length and a width that are similar to a length and width of the back panel 48. While the first closure portion 60 may be formed from a single piece, the first closure portion 60 is preferably fabricated from an inner panel 70 and an outer panel 72, as illustrated in FIGS. 5, 6 and 9. Fabricating the first closure portion 60 in the two-part configuration enables the first closure portion 60 to resist bending when in the open position while providing an aesthetically appealing relatively smooth outer surface and an inner surface having recesses or other features that facilitate retaining objects in a desired position, as is described in more detail below.

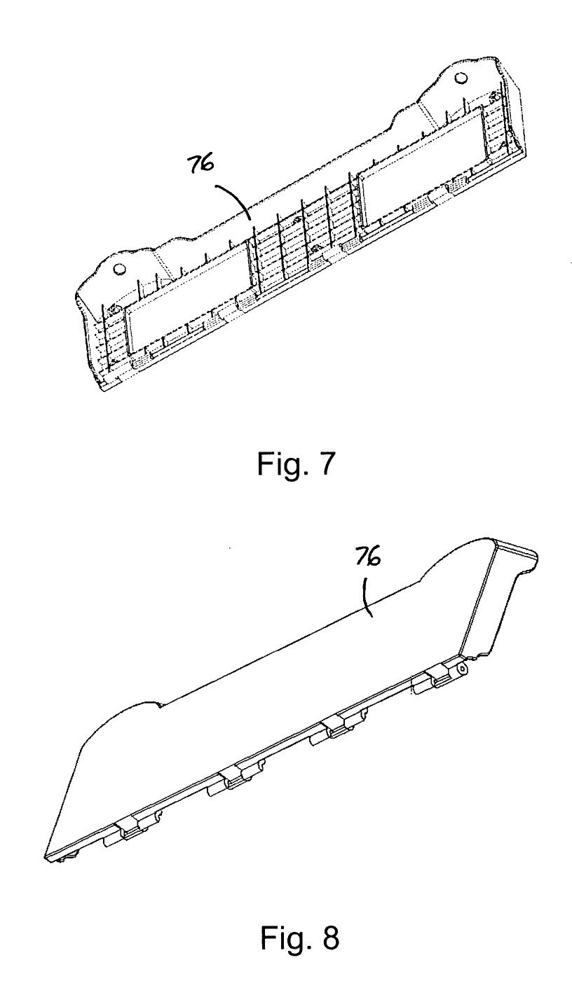

The second closure portion 62 preferably has a length and a width that are similar to a length and a width of an upper opening of the partially enclosed region 52. While the second closure portion 62 may be formed from a single piece, the second closure portion 62 is preferably fabricated from an inner panel 74 and an outer panel 76, as illustrated in FIGS. 7, 8 and 10. Fabricating the second closure portion 62 in the two-part configuration enables the second closure portion 62 to resist bending when in the open position while providing an aesthetically appealing relatively smooth outer surface and an inner surface having recesses or other features that facilitate retaining objects in a desired position, as is described in more detail below.

The closure section 42 is preferably pivotally attached to the ladder section 20 using a pair of fastening mechanisms 43. Each of the fastening mechanisms preferably extends through the closure section 42 into the main section 40 and then through the side rail 30.

The closure section 42 is pivotable between a closed configuration (FIG. 1) and an extended configuration (FIG. 2). When the closure section 42 is in the closed position, the first closure portion 60 is preferably substantially parallel to the back panel 48 and the second closure portion 62 substantially seal the upper opening of the partially enclosed region 52.

When the closure section 42 is in the extended configuration, the second closure portion 62 is pivoted to a substantially parallel orientation with respect to the first closure portion 60 and the bottom panel 46 such that the closure section 42 provides a substantially flat surface on which objects such as screwdrivers and pain cans may be placed.

The inner surfaces of at least one of the first closure portion 60 and the second closure portion 62 preferably include at least one recess 80 to maintain objects in a desired position with respect to the closure section 42. The inner surfaces of the first closure portion 60 and the second closure portion 62 may also include at least one extension and at least one aperture for maintaining objects in a stationary position with respect to the closure section 42.

The components of the ladder 12 and the storage compartment 14 are preferably either fabricated from metallic materials or plastic materials to provide the ladder 12 with a relatively light weight yet durable construction.

In operation, the ladder 12 is moved a desired use location with the first and second ladder sections 20, 22 in a closed position where they are substantially adjacent to each other. The first and second ladder sections 20, 22 are then pivoted apart from each other and the ladder 12 is placed in a standing orientation on a surface where the ladder 12 is to be used.

The storage compartment 14 is initially in a closed position where the first closure portion 60 is adjacent the back panel 48 and the second closure portion 62 substantially covers the partially enclosed region 52.

When it is desired to access objects stored in the storage compartment 14 or when it is desired to rest on the storage compartment 14, the second closure section 62 is pivoted with respect to the first closure portion 60 and the first closure portion 60 is pivoted with respect to the storage section 40 until the first and second closure portion 60, 62 are in a substantially horizontal orientation.

Once done using the ladder 12, objects may be placed in the partially enclosed region 52 for storage. The first and second closure portions 60, 62 are then pivoted to the closed position and the first and second ladder sections 20, 22 are pivoted towards each other.

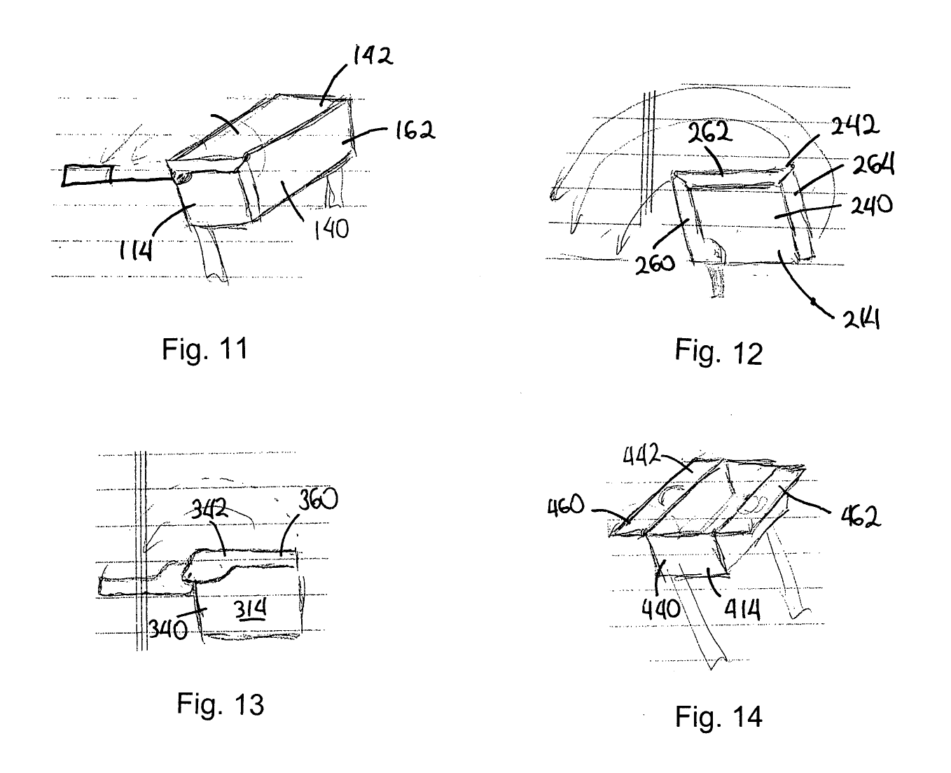

In an alternative configuration of the storage compartment 114, as illustrated in FIG. 11, the closure section 142 is attached proximate an upper edge of the storage section 140 and the closure section 142 includes first and second closure portions 160, 162 that are pivotally attached to each other.

In another configuration of the storage compartment 214, as illustrated in FIG. 12, the closure section 242 is attached proximate a lower edge of the storage section 240. The closure section 242 includes first, second and third closure portions 260, 262, 264 that are pivotally attached to each other.

In still another configuration of the storage compartment 314, as illustrated in FIG. 13, the closure section 342 is attached proximate an upper edge of the storage section 340. The closure section 342 includes a single closure portion 360 that is pivotally attached to the storage section 340.

In yet another configuration of the storage compartment 414, as illustrated in FIG. 14, the closure section 442 includes first and second closure portions 460, 462 that are separately attached to the storage section 440 so that they can pivot apart from each other to access objects in the storage section 440.

It is contemplated that features disclosed in this application, as well as those described in the above applications incorporated by reference, can be mixed and matched to suit particular circumstances. Various other modifications and changes will be apparent to those of ordinary skill.

1. A ladder comprising:
a first ladder section;
a second ladder section that is operably attached to the first ladder section; and
a storage compartment that is attached to at least one of the first ladder section and the second ladder section, wherein the storage compartment comprises:
a storage section having a partially enclosed region formed therein; and
a closure section operably connected to the storage section, wherein the closure section comprises a first closure portion and a second closure portion that are operably connected to each other, wherein the closure section is movable between a closed position where the closure section substantially encloses the partially enclosed region and an open position where the closure section has a support surface that is capable of supporting at least one object.

2. The ladder of claim 1, wherein the first closure portion is pivotally mounted with respect to the storage section and the second closure portion.

3. The ladder of claim 1, wherein the first closure portion and the second closure portion each have an inner panel and an outer panel.

4. The ladder of claim 3, wherein at least one of the inner panels has a recess formed therein, an extension formed thereon, an aperture formed therein, or combinations thereof.

5. The ladder of claim 3, and further comprising at least one reinforcing member that extends substantially between the inner panel and the outer panel.

6. The ladder of claim 1, and further comprising a closure mechanism for maintaining the closure section in a stationary position with respect to the storage section.

7. The ladder of claim 1, and further comprising at least one step operably attached to at least one of the first ladder section and the second ladder section.

8. The ladder of claim 1, wherein the first ladder section is pivotably attached to the second ladder section.

9. A method of storing objects with respect to a ladder, wherein the method comprises:
providing a ladder having a first ladder section and a second ladder section that is operably attached to the first ladder section;
mounting a storage compartment with respect to at least one of the first ladder section and the second ladder section, wherein the storage compartment has a partially enclosed region formed therein;
operably attaching a closure section to the storage compartment, wherein the closure section includes a first closure portion and a second closure portion that are pivotally attached to each other; and
moving the closure second between a closed position and an open position, wherein the closure portion substantially encloses the partially enclosed region when in the closed position, and wherein the closure section is capable of supporting at least one object when in the open position.

10. The method of claim 9, wherein the first closure portion is pivotally mounted with respect to the storage compartment and the second closure portion.

11. The method of claim 9, wherein the first closure portion and the second closure portion each have an inner panel and an outer panel.

12. The method of claim 11, wherein at least one of the inner panels has a recess formed therein, an extension formed thereon, an aperture formed therein, or combinations thereof.

13. The method of claim 11, and further comprising at least one reinforcing member that extends substantially between the inner panel and the outer panel.

14. The method of claim 9, and further comprising a closure mechanism for maintaining the closure section in a stationary position with respect to the storage compartment.

15. The method of claim 9, and further comprising operably attaching at least one step to at least one of the first ladder section and the second ladder section.

16. The method of claim 9, wherein the first ladder section is pivotably attached to the second ladder section.
